(19) United States
(12) Patent Application Publication
(10) Pub. No.: US 2026/0238742 A1
(43) Pub. Date: Aug. 13, 2026

(54) VIDEO TRANSMISSION SYSTEM

(71) Applicant: ROHM Co., Ltd., Kyoto (JP)

(72) Inventors: Naoki Sugiuchi, Kyoto (JP); Tomoyuki Ichikawa, Kyoto (JP)

(73) Assignee: ROHM Co., Ltd., Kyoto (JP)

(21) Appl. No.: 19/530,356

(22) Filed: Feb. 5, 2026

(30) Foreign Application Priority Data
Feb. 12, 2025 (JP) 2025-020773

(51) Int. Cl. H04N 7/173; H04N 7/083

(52) U.S. Cl. CPC H04N 7/17318; H04N 7/083

(57) ABSTRACT

A video transmission system includes an encoder, which includes a first transmission part that transmits a specific signal for communication establishment to a decoder via a first communication line during a blanking period of video data, and a determination part that determines communication establishment of back channel communication in a case of receiving a command signal indicating communication establishment from the decoder via a second communication line after transmission of the specific signal. The decoder includes a judgment part that judges whether or not a signal received from the encoder during the blanking period is the specific signal; and a second transmission part that transmits the command signal to the encoder via the second communication line in a case of the received signal being the specific signal, and the encoder and the decoder execute the back channel communication via the second communication line after determination of the communication establishment.

### CROSS-REFERENCE TO RELATED APPLICATION

This application claims the priority benefits of Japanese application no. 2025-020773, filed on February 12, 2025. The entirety of the above-mentioned patent application is hereby incorporated by reference herein and made a part of this specification.

### BACKGROUND

### Technical Field

The disclosure relates to a video transmission system that transmits video data between an encoder and a decoder.

### Related Art

Recently, video transmission systems that transmit video captured by a camera from one communication device to another communication device via a communication line as video data converted to serial data have been used in vehicles and the like (Patent Document 1: Japanese Patent Application Laid-Open Publication No. 2024-093153). In conventional video transmission systems, typically, one communication device includes an encoder for serial data conversion, and the another communication device includes a decoder for parallel data conversion.

In conventional video transmission systems, since video data transmission is unidirectional communication from one communication device to another communication device, back channel communication is configured to enable data transmission from the another communication device to the one communication device for data communication other than video data. Back channel communication enables, for example, changing the communication mode of video data or changing the shooting mode of the camera from another communication device to the one communication device.

However, this presented a problem in that in a state where communication establishment between communication devices is not correctly performed for back channel communication, malfunction or failure may be caused during data transmission in back channel communication.

Therefore, an object of the disclosure is to provide a video transmission system that is capable of reliably performing communication establishment between communication devices for back channel communication.

### SUMMARY

The video data transmission system of the disclosure is a video transmission system for transmitting video data from an encoder to a decoder via a first communication line, in which the encoder includes: a first transmission part that transmits a specific signal for communication establishment to the decoder via the first communication line during a blanking period of the video data; and a determination part that determines communication establishment of back channel communication in a case of receiving a command signal indicating communication establishment from the decoder via a second communication line after transmission of the specific signal. The decoder includes a judgment part that judges whether or not a signal received from the encoder during the blanking period is the specific signal; and a second transmission part that transmits the command signal to the encoder via the second communication line in a case of the received signal being the specific signal, and the encoder and the decoder execute the back channel communication via the second communication line after determination of the communication establishment of the back channel communication.

The video data transmission system of the disclosure is a video transmission system for transmitting video data from an encoder to a decoder via a first communication line. The video transmission system includes a control unit that is connected to the decoder, and that issues a communication establishment request to the decoder in response to receiving a specific signal detection notification. The encoder includes a first transmission part that transmits a specific signal for communication establishment to the decoder via the first communication line during a blanking period of the video data; and a determination part that determines communication establishment of back channel communication in a case of receiving a command signal indicating communication establishment from the decoder via a second communication line after transmission of the specific signal. The decoder includes a judgment part that judges whether or not a signal received from the encoder during the blanking period is the specific signal; a notification part that supplies the specific signal detection notification to the control unit in a case of the received signal being the specific signal; and a second transmission part that transmits the command signal to the encoder via the second communication line according to the communication establishment request, and the encoder and the decoder execute the back channel communication via the second communication line after determination of the communication establishment of the back channel communication.

### BRIEF DESCRIPTION OF THE DRAWINGS

FIG. 1 is a block diagram showing a video transmission system of the disclosure.

FIG. 2 is a sequence diagram showing a communication establishment operation of back channel communication in the system of FIG. 1.

FIGS. 3A to 3C are diagrams showing a success pattern of a communication establishment operation of back channel communication in the system of FIG. 1.

FIGS. 4A to 4C are diagrams showing a failure pattern of a communication establishment operation of back channel communication in the system of FIG. 1.

FIGS. 5A to 5C are diagrams showing a failure pattern of a communication establishment operation of back channel communication in the system of FIG. 1.

### DESCRIPTION OF THE EMBODIMENTS

Hereinafter, the video transmission system of the disclosure will be described in detail with reference to the drawings.

### Example

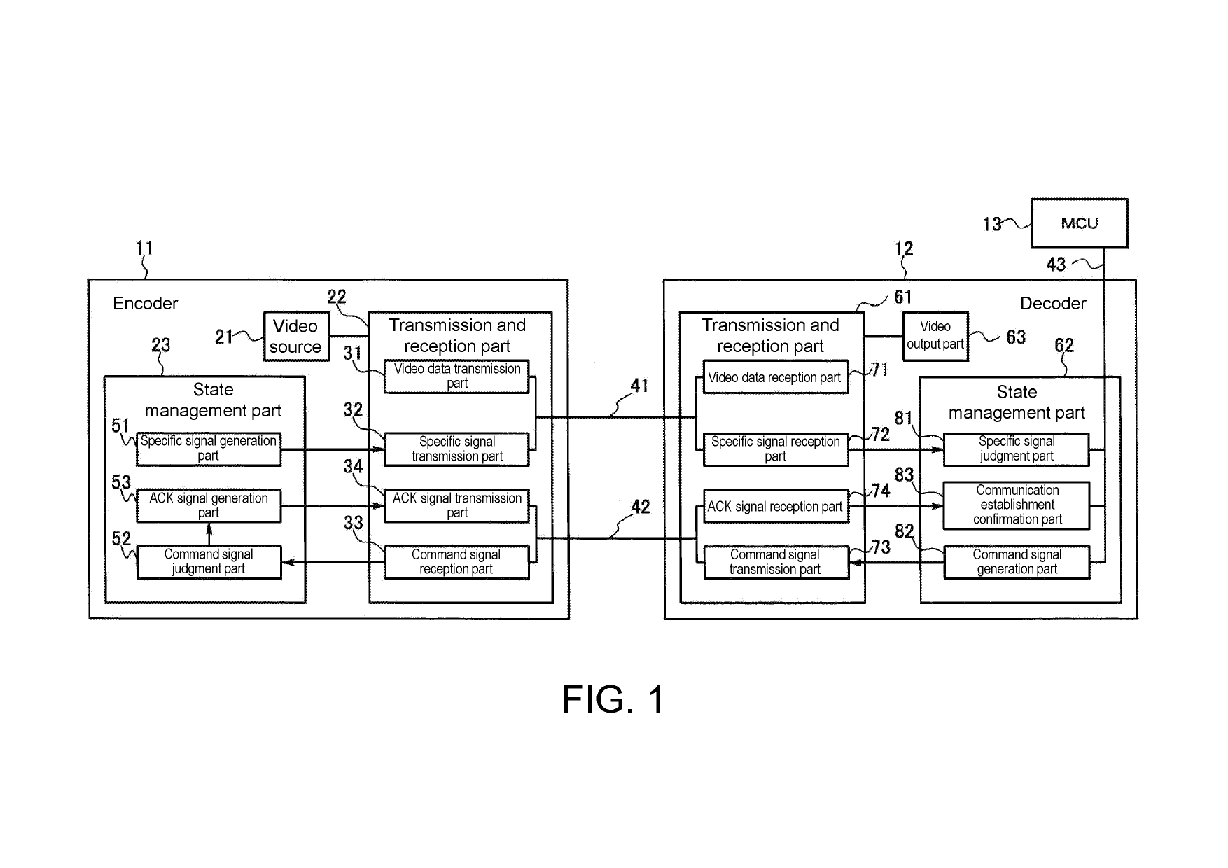

FIG. 1 shows the video transmission system of the disclosure. This video transmission system includes, as communication devices, an encoder 11, a decoder 12, and an MCU (Microcontroller Unit) 13. The encoder 11 and the decoder 12 are connected to each other by communication lines 41 and 42. The decoder 12 and a MCU 13 are connected to each other by a data line 43.

The encoder 11 includes a video source 21, a transmission and reception part 22, and a state management part 23. The video source 21 is, for example, a camera and generates a video signal that is parallel data. The transmission and reception part 22 is connected to the video source 21 and is a part that performs data communication including video data with the decoder 12. The transmission and reception part 22 includes a video data transmission part 31, a specific signal transmission part 32, a command signal reception part 33, and an ACK (ACKnowledgement) signal transmission part 34. The communication line 41 is connected to the video data transmission part 31 and the specific signal transmission part 32, and the communication line 42 is connected to the command signal reception part 33 and the ACK signal transmission part 34. The communication line 41 is a first communication line and is a unidirectional communication line. The communication line 42 is a second communication line for back channel communication and is a communication line capable of bidirectional communication. Back channel communication is communication performed from the decoder 12 toward the encoder 11.

The video data transmission part 31 converts the video signal supplied from the video source 21 into video data that is serial data, and transmits the video data to the decoder 12 via the communication line 41. The specific signal transmission part 32 inserts the specific signal supplied from the state management part 23 into a blanking period of the video data and transmits it to the decoder 12 via the communication line 41. The blanking period is other than the video portion of the video data and the vertical and horizontal sync signal portions, and is a period that is not displayed on the screen of the display. The specific signal is a signal that instructs the start of back channel communication. The command signal reception part 33 receives the command signal transmitted from the decoder 12 via the communication line 42. The command signal is a signal generated by the MCU 13. The ACK signal transmission part 34 transmits the ACK signal supplied from the state management part 23 to the decoder 12 via the communication line 42.

The state management part 23 is a part that manages the operating state of the transmission and reception part 22. The state management part 23 includes a specific signal generation part 51, a command signal judgment part 52, and an ACK signal generation part 53.

The specific signal generation part 51 generates a specific signal and supplies the specific signal to the specific signal transmission part 32. The generation of the specific signal by the specific signal generation part 51 may be performed, for example, according to an input operation from the outside, or may be performed automatically at predetermined time intervals. The specific signal is composed of a predetermined code sequence, for example, ABCD. The command signal judgment part 52 accepts the command signal received by the command signal reception part 33 and judges whether or not the command signal is a predetermined command signal. The ACK signal generation part 53 generates an ACK signal according to the judgement result by the command signal judgment part 52. That is, the ACK signal is generated in the case where it is judged that the received command signal is a predetermined command signal. The ACK signal generation part 53 supplies the generated ACK signal to the ACK signal transmission part 34.

The decoder 12 includes a transmission and reception part 61, a state management part 62, and a video output part 63. The transmission and reception part 61 includes a video data reception part 71, a specific signal reception part 72, a command signal transmission part 73, and an ACK signal reception part 74. The communication line 41 is connected to the video data reception part 71 and the specific signal reception part 72, and the communication line 42 is connected to the command signal transmission part 73 and the ACK signal reception part 74.

The video data reception part 71 receives the video data transmitted from the encoder 11 via the communication line 41. The specific signal reception part 72 receives the specific signal transmitted from the encoder 11 via the communication line 41. The command signal transmission part 73 transmits the command signal supplied from the state management part 62 to the encoder 11 via the communication line 42. The ACK signal reception part 74 receives the ACK signal transmitted from the encoder 11 via the communication line 42.

The state management part 62 is a part that manages the operating state of the transmission and reception part 61. The state management part 62 includes a specific signal judgment part 81, a command signal generation part 82, and a communication establishment confirmation part 83.

The specific signal judgment part 81 accepts the specific signal received by the specific signal reception part 72 and judges whether or not the specific signal indicates a predetermined code sequence. The judgement result of the specific signal judgment part 81 is supplied to the MCU 13 via the data line 43. The command signal generation part 82 is connected to the MCU 13 via the data line 43 and generates a command signal indicating predetermined communication establishment according to a communication establishment request from the MCU 13. The communication establishment here is establishment of a connection for back channel communication using the communication line 42 between the encoder 11 and the decoder 12. The command signal generation part 82 supplies the generated command signal to the command signal transmission part 73. The communication establishment confirmation part 83 accepts the ACK signal received by the ACK signal reception part 74 and confirms communication establishment between the encoder 11 and the decoder 12 via the communication line 42 according to the ACK signal.

The video output part 63 is connected to the transmission and reception part 61, and the video data received by the video data reception part 71 is supplied to the video output part 63. For example, the video output part 63 is a display that displays the video indicated by the supplied video data or a storage device that stores the video data.

The MCU 13 is a host device and is connected to the decoder 12 via the data line 43 as described above. The MCU 13 is enabled to receive, via the data line 43, a judgement result indicating that the specific signal indicates a predetermined code sequence from the specific signal judgment part 81 as a specific signal detection notification. In the case of receiving the specific signal detection notification, the MCU 13 supplies a communication establishment request to the command signal generation part 82 via the data line 43. The communication establishment request may be generated only in the case of requiring back channel communication. Moreover, the MCU 13 receives a communication establishment notification from the communication establishment confirmation part 83 via the data line 43 in the case where the communication establishment of back channel communication is confirmed by the communication establishment confirmation part 83.

Back channel communication is communication via the communication line 42 as described above, and in this embodiment is serial communication using an I2C (Inter-Integrated Circuit) communication method. In I2C communication, the communication line 42 includes a signal line for data and a signal line for clock. Moreover, although not illustrated, each of the transmission and reception part 22 of the encoder 11 and the transmission and reception part 61 of the decoder 12 includes a transmission and reception part for data communication using the I2C communication method.

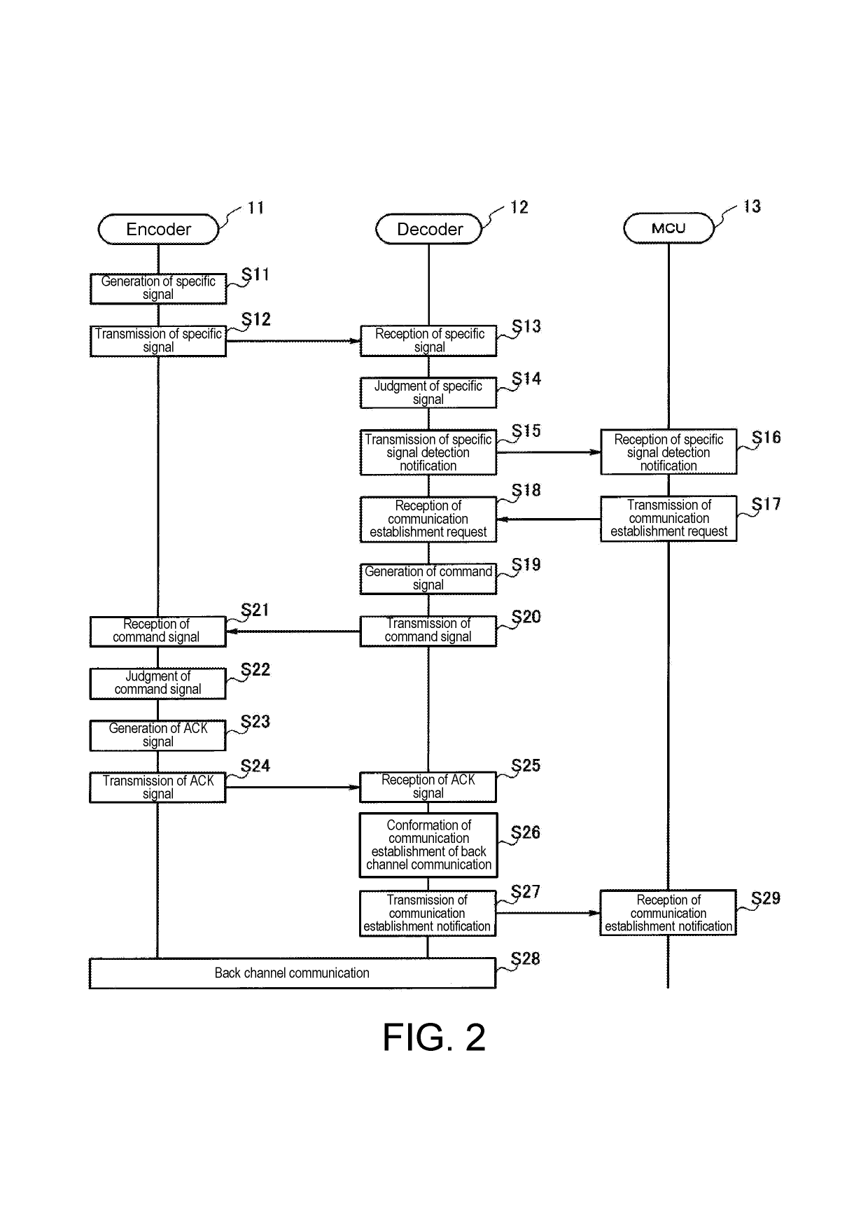

Next, the communication establishment operation of back channel communication in the video transmission system having such configuration will be described using the sequence diagram of FIG. 2.

In the encoder 11, for example, the specific signal generation part 51 generates a specific signal according to an instruction from outside (step S11), and the specific signal is transmitted from the specific signal transmission part 32 to the decoder 12 via the communication line 41 (step S12). The specific signal is superimposed on the blanking period of the video data during transmission.

In the decoder 12, the specific signal reception part 72 receives by extracting a signal other than video data from the blanking period of the video data that arrived via the communication line 41 (step S13). The received signal is supplied to the specific signal judgment part 81. In the specific signal judgment part 81, it is judged whether or not the received signal indicates a specific signal including a predetermined code sequence (step S14). In the case of the received signal indicating a specific signal of a predetermined code sequence, the judgement result is supplied to the MCU 13 as a specific signal detection notification via the data line 43 (step S15).

In the MCU 13, in response to receiving the specific signal detection notification (step S16), a communication establishment request is generated, and the communication establishment request is supplied to the command signal generation part 82 via the data line 43 (step S17).

In the command signal generation part 82, in response to receiving the communication establishment request from the MCU 13 (step S18), a command signal indicating communication establishment is generated according to the communication establishment request, and the command signal is supplied to the command signal transmission part 73 (step S19). In the command signal transmission part 73, the command signal is transmitted to the encoder 11 via the communication line 42 (step S20). The transmission of the command signal via the communication line 42 may be performed during the blanking period of the video data.

In the encoder 11, the command signal transmitted in step S20 is received by the command signal reception part 33 (step S21). The received command signal is supplied to the command signal judgment part 52, and the command signal judgment part 52 judges whether or not it is a predetermined command signal (step S22). In the case of the received command signal being a predetermined command signal, an ACK signal is generated by the ACK signal generation part 53 (step S23). The generated ACK signal is supplied to the ACK signal transmission part 34, and is transmitted to the decoder 12 via the communication line 42 by the ACK signal transmission part 34 (step S24).

In the decoder 12, the ACK signal transmitted in step S24 is received by the ACK signal reception part 74 (step S25). The received ACK signal is supplied to the communication establishment confirmation part 83, and the communication establishment of back channel communication is confirmed by the communication establishment confirmation part 83 in response to the reception of the ACK signal (step S26). In response to the communication establishment being confirmed in step S26, a communication establishment notification is transmitted to the MCU 13 via the data line 43 (step S27).

Moreover, in response to the communication establishment of back channel communication being confirmed, in addition to the transmission of video data from the encoder 11 to the decoder 12, back channel communication from the decoder 12 to the encoder 11 is possible (step S28). In response to receiving the communication establishment notification (step S29), the MCU 13 may control transmission data from the decoder 12 to the encoder 11 in a state where back channel communication is possible between the encoder 11 and the decoder 12. Moreover, the MCU 13 may instruct transmission and reception of data for performing operation settings of the encoder 11 and devices connected thereto, such as write/read of registers in the encoder 11, control of SPI-flash memory connected to the encoder 11, I2C write/read to other devices connected to an I2C bus connected to the encoder 11, and the like.

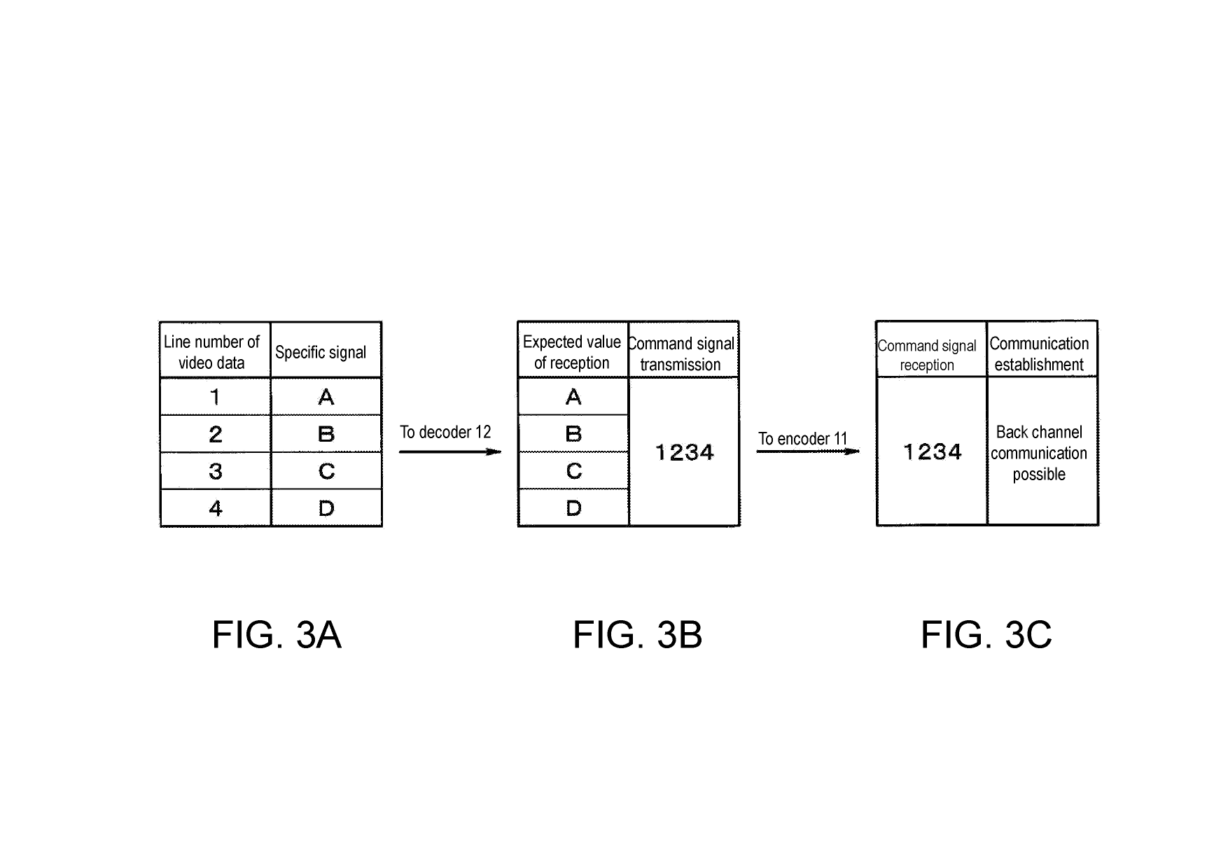

As described above, the predetermined code sequence of the specific signal is transmitted by the specific signal transmission part 32 of the encoder 11 so as to be arranged in the blanking period of the video data. The predetermined code sequence of the specific signal is arranged in the blanking period of any or predetermined single line of the video data, or is distributed and arranged in the blanking periods of predetermined multiple lines in one frame of video data. For example, in the case of the code sequence “ABCD” , as shown in FIG. 3A, distributed arrangement is performed with “A” arranged in line number 1 of the video data, “B” arranged in line number 2, “C” arranged in line number 3, and “D” arranged in line number 4. Moreover, the code sequence “ABCD” may be sequentially arranged in any one or more arbitrary lines in one frame of the video data.

In the decoder 12, in the case of the signal received by the specific signal reception part 72 being “ABCD” of FIG. 3A, in the case of “ABCD” being present in the specific signal judgment part 81 as an expected value of reception as shown in FIG. 3B as a predetermined code sequence, the specific signal judgment part 81 performs match judgement and generates a specific signal detection notification. Thereby, the MCU 13 generates a communication establishment request, and the command signal generation part 82 generates a command signal including the fixed value “1234” as shown in FIG. 3B, and the command signal is transmitted from the command signal transmission part 73.

In the encoder 11, as shown in FIG. 3C, in the case of a command signal including the fixed value “1234” being received, the command signal judgment part 52 judges that it is a predetermined command signal, and communication establishment is confirmed. As a result, back channel communication becomes possible using the communication line 42.

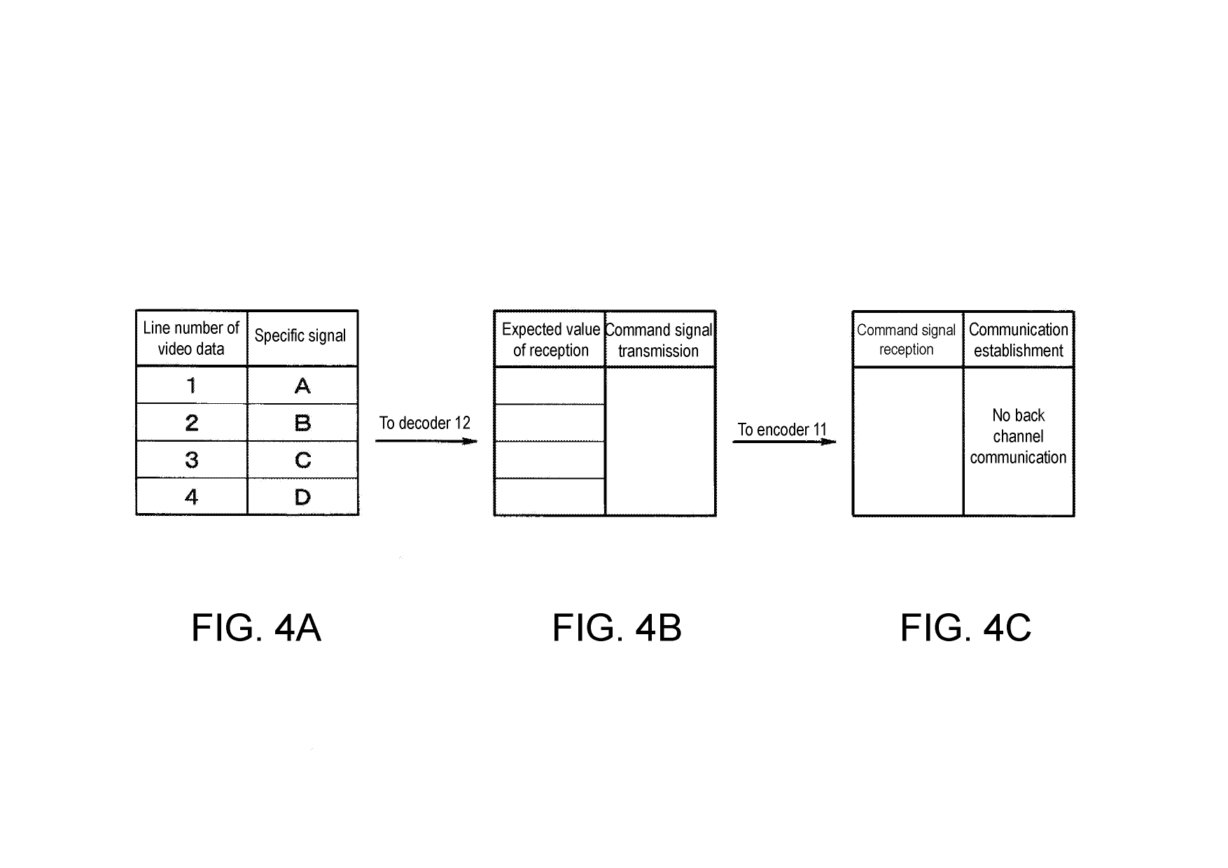

On the other hand, in the decoder 12, even in the case of the signal received by the specific signal reception part 72 being “ABCD” of FIG. 4A, in response to “ABCD” not being present in the specific signal judgment part 81 as shown in FIG. 4B as an expected value of reception as a predetermined code sequence, since no specific signal detection notification is generated, no command signal is generated, and as shown in FIG. 4C, communication establishment is not performed.

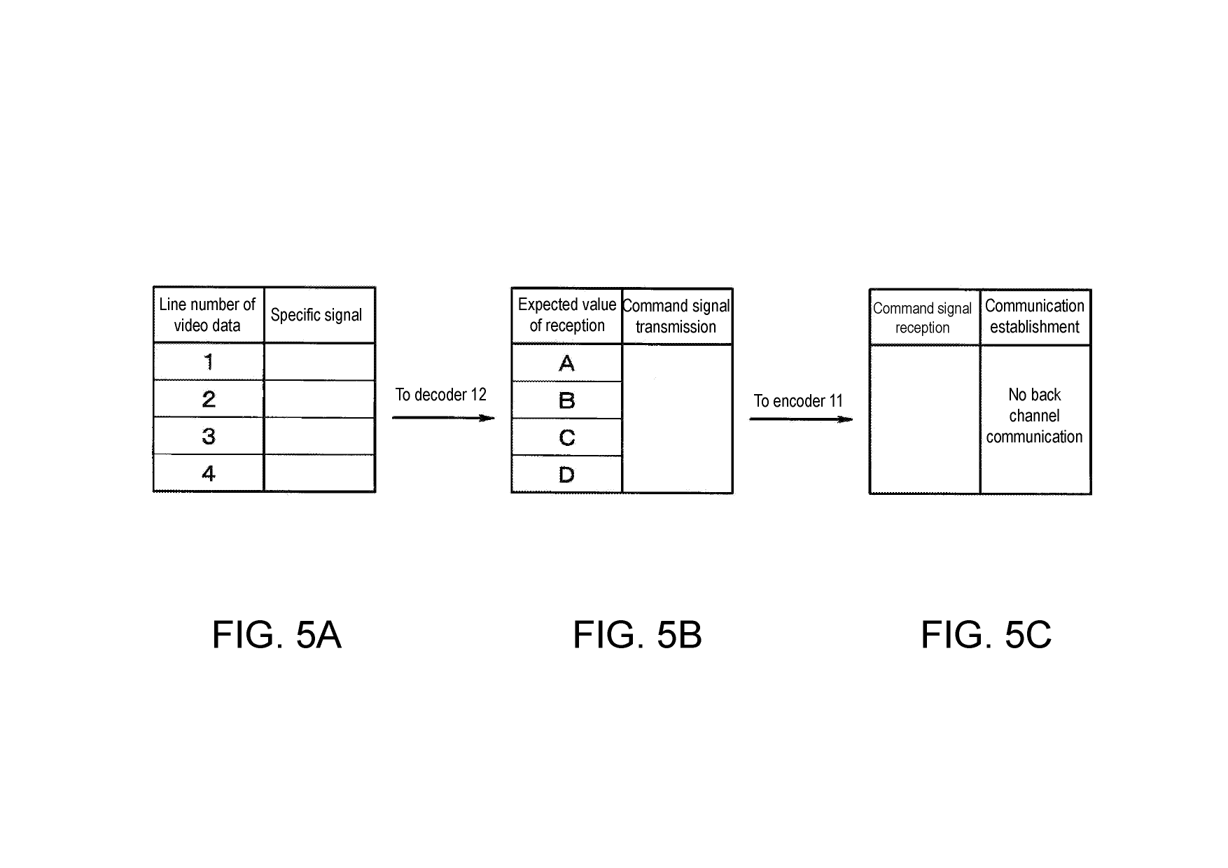

As shown in FIG. 5A, in the case of the specific signal not being inserted in the blanking period of the video data in the encoder 11, even though “ABCD” is present in the specific signal judgment part 81 as an expected value of reception as a predetermined code sequence as shown in FIG. 5B, the specific signal judgment part 81 cannot recognize the specific signal by match judgement. In this case as well, since no specific signal detection notification is generated, no command signal is generated, and as shown in FIG. 5C, communication establishment is not performed.

In the case of communication establishment not being performed in this manner, back channel communication is not executed, and transmission of video data from the encoder 11 toward the decoder 12 is continued.

According to the video transmission system of the disclosure, communication establishment in back channel communication can be reliably executed, and data transmission by back channel communication can be started after communication establishment confirmation, so malfunctions and failures can be prevented during back channel communication.

Moreover, the video transmission system of this embodiment includes the MCU 13, but the MCU 13 is not essential in the video transmission system. The decoder 12 may transmit a command signal to the encoder 11 without transmitting a specific signal detection notification to the MCU 13 in the case of performing reception and judgement of the specific signal transmitted from the encoder 11.

The disclosure is not limited to the forms of the embodiments described above, and various improvements and design changes are possible within a range that does not depart from the gist of the disclosure.

### Supplementary Notes

The following configurations are disclosed in this specification.

### Configuration 1

A video transmission system for transmitting video data from an encoder to a decoder via a first communication line, in which the encoder includes a first transmission part that transmits a specific signal for communication establishment to the decoder via the first communication line during a blanking period of the video data; and a determination part that determines communication establishment of back channel communication in a case of receiving a command signal indicating communication establishment from the decoder via a second communication line after transmission of the specific signal, and the decoder includes a judgment part that judges whether or not a signal received from the encoder during the blanking period is the specific signal; and a second transmission part that transmits the command signal to the encoder via the second communication line in a case of the received signal being the specific signal, and the encoder and the decoder execute the back channel communication via the second communication line after determination of the communication establishment of the back channel communication.

### Configuration 2

The video transmission system according to configuration 1, in which the specific signal includes a predetermined code sequence.

### Configuration 3

The video transmission system according to configuration 2, in which the code sequence is distributed and arranged in a plurality of lines in one frame of the video data.

### Configuration 4

The video transmission system according to configuration 1, in which bidirectional communication is possible on the second communication line.

### Configuration 5

The video transmission system according to configuration 1, in which data is transmitted from the decoder to the encoder via the second communication line during execution of the back channel communication.

### Configuration 6

The video transmission system according to any one of configurations 1 to 5, in which the second communication line is a communication line for Inter-Integrated Circuit communication.

### Configuration 7

The video transmission system according to any one of configurations 1 to 5, in which the second transmission part transmits the command signal during the blanking period.

### Configuration 8

A video transmission system for transmitting video data from an encoder to a decoder via a first communication line, the system including: a control unit that is connected to the decoder, and that issues a communication establishment request to the decoder in response to receiving a specific signal detection notification. The encoder includes: a first transmission part that transmits a specific signal for communication establishment to the decoder via the first communication line during a blanking period of the video data; and a determination part that determines communication establishment of back channel communication in a case of receiving a command signal indicating communication establishment from the decoder via a second communication line after transmission of the specific signal. The decoder includes: a judgment part that judges whether or not a signal received from the encoder during the blanking period is the specific signal; a notification part that supplies the specific signal detection notification to the control unit in a case of the received signal being the specific signal; and a second transmission part that transmits the command signal to the encoder via the second communication line according to the communication establishment request, and the encoder and the decoder execute the back channel communication via the second communication line after determination of the communication establishment of the back channel communication.

What is claimed is:

1. A video transmission system for transmitting video data from an encoder to a decoder via a first communication line,
wherein the encoder includes:
a first transmission part that transmits a specific signal for communication establishment to the decoder via the first communication line during a blanking period of the video data; and
a determination part that determines communication establishment of back channel communication in a case of receiving a command signal indicating communication establishment from the decoder via a second communication line after transmission of the specific signal,
wherein the decoder includes:
a judgment part that judges whether or not a signal received from the encoder during the blanking period is the specific signal; and
a second transmission part that transmits the command signal to the encoder via the second communication line in a case of the received signal being the specific signal,
wherein the encoder and the decoder execute the back channel communication via the second communication line after determination of the communication establishment of the back channel communication.

2. The video transmission system according to claim 1, wherein the specific signal comprises a predetermined code sequence.

3. The video transmission system according to claim 2, wherein the code sequence is distributed and arranged in a plurality of lines in one frame of the video data.

4. The video transmission system according to claim 1, wherein bidirectional communication is possible on the second communication line.

5. The video transmission system according to claim 1, wherein data is transmitted from the decoder to the encoder via the second communication line during execution of the back channel communication.

6. The video transmission system according to claim 1, wherein the second communication line is a communication line for Inter-Integrated Circuit communication.

7. The video transmission system according to claim 2, wherein the second communication line is a communication line for Inter-Integrated Circuit communication.

8. The video transmission system according to claim 3, wherein the second communication line is a communication line for Inter-Integrated Circuit communication.

9. The video transmission system according to claim 4, wherein the second communication line is a communication line for Inter-Integrated Circuit communication.

10. The video transmission system according to claim 5, wherein the second communication line is a communication line for Inter-Integrated Circuit communication.

11. The video transmission system according to claim 1, wherein the second transmission part transmits the command signal during the blanking period.

12. The video transmission system according to claim 2, wherein the second transmission part transmits the command signal during the blanking period.

13. The video transmission system according to claim 3, wherein the second transmission part transmits the command signal during the blanking period.

14. The video transmission system according to claim 4, wherein the second transmission part transmits the command signal during the blanking period.

15. The video transmission system according to claim 5, wherein the second transmission part transmits the command signal during the blanking period.

16. A video transmission system for transmitting video data from an encoder to a decoder via a first communication line, the video transmission system comprising:
a control unit that is connected to the decoder, and that issues a communication establishment request to the decoder in response to receiving a specific signal detection notification,
wherein the encoder includes:
a first transmission part that transmits a specific signal for communication establishment to the decoder via the first communication line during a blanking period of the video data; and
a determination part that determines communication establishment of back channel communication in a case of receiving a command signal indicating communication establishment from the decoder via a second communication line after transmission of the specific signal,
wherein the decoder includes:
a judgment part that judges whether or not a signal received from the encoder during the blanking period is the specific signal;
a notification part that supplies the specific signal detection notification to the control unit in a case of the received signal being the specific signal; and
a second transmission part that transmits the command signal to the encoder via the second communication line according to the communication establishment request,
wherein the encoder and the decoder execute the back channel communication via the second communication line after determination of the communication establishment of the back channel communication.
